(19) United States
(12) Patent Application Publication
(10) Pub. No.: US 2025/0351760 A1
(43) Pub. Date: Nov. 20, 2025

(54) COMBINED MACHINE SYSTEM THAT PROVIDES LAND PROCESSING BEFORE SUCCESSIVE PLANTING

(71) Applicant: TARIMOZ TARIM MAKINALARI SANAYI VE TICARET A.S., Konya (TR)

(72) Inventor: Ahmet ARSLAN, Konya (TR)

(73) Assignee: TARIMOZ TARIM MAKINALARI SANAYI VE TICARET A.S., Konya (TR)

(21) Appl. No.: 18/567,781

(22) PCT Filed: Dec. 13, 2022
(86) PCT No.: PCT/TR2022/051485

§ 371 Date: Dec. 7, 2023

(30) Foreign Application Priority Data
Nov. 29, 2022 (WO) PCT/TR2022/018137

(51) Int. Cl. A01B 49/02; A01B 29/04; A01B 33/02; A01B 35/08; A01B 71/00

(52) U.S. Cl. CPC A01B 49/022; A01B 29/04; A01B 33/024; A01B 35/08; A01B 71/00

(57) ABSTRACT

A machine that allows for processing the plant as much as the area where the plant requires and makes the seed bed ready for planting at once and in a single process, for plants planted in the range of 45-70 cm, such as corn, cotton, beet, sunflower, and beans in agricultural areas.

### CROSS REFERENCE TO RELATED APPLICATIONS

This application is a national stage entry of International Application No. PCT/TR2022/051485, filed on Dec. 13, 2022, which is based upon and claims foreign priority to Turkey Patent Application No. TR2022/018137, filed on Nov. 29, 2022, the entire contents of which are incorporated herein by reference.

### TECHNICAL FIELD

The present invention relates to a machine that allows for processing the plant as much as the area where the plant requires and makes the seed bed ready for planting at once and in a single process, for plants planted in the range of 45-70 cm, such as corn, cotton, beet, sunflower, and beans in agricultural areas.

### BACKGROUND

Typically, various equipment is traded in order to gain the most productive structure before insemination. These operations can be listed under the topics such as explosion of the cultivation area, stuck soil, disposal of organic substances, and determination of cultivation rows.

The machines called plow, blasting, bottom boiler, rotovator, sweep, harrow, and tiller, that provide these operations are the machines where each machine should be used respectively in order to make planting on the land. Since the land is processed one by one with each machine used, it creates a serious fuel and time consumption. This is reflected in the unit product cost for the manufacturer.

In another aspect, even in corn, etc., they process the whole land even in products. The fact that the intermediate gaps that will not be used in planting is also processed means additional load and resistance to both the tractor and the machine.

All factors form labor, energy, and time consumption. In addition, since many operations are performed in the soil, deterioration in the structure of the soil may occur. In this arrangement, areas that do not need unnecessary plants are also processed, that is, the entire land is processed and the cost of fuel, time, and labor increases.

Machines such as rotovator, sweep, harrow, and tiller move towards the direction of the tractor as of their structure and work in the direction of pulling the tractor. For this reason, they can only perform one stroke to the stone, plant residue, and roots after harvesting. This single stroke is not enough to break down the stone, plant residue and roots, and prevent these residues from mixing into the soil and remain on the surface. For this reason, they delay organic decay and prevent and disrupt the preparation of the appropriate seed bed. It has to be disintegrated with machines such as plant resources and stem shredding machine for roots. This doubles the necessary workforce, costs, and time as a second process.

Consequently, the disadvantages disclosed above in this regard necessitated making an innovation and development that enables the valuation of external substances such as stone and grass on the land by processing the soil at a single process.

### SUMMARY

Due to the compactness of our cultivable areas and the negativities of economic conditions, juicy agriculture is preferred due to its gain, and planting areas are tried to be left to rest (fallowing). Ribbon-like models have started to be applied in lands. However, it is aimed to solve negativity since the combined machines formed to capture a depth of 20-30 cm with these machines and to carry out the desired operations (blasting-shredding-soil compaction) are very heavy and they do not provide the desired result.

The present invention increases productivity by ensuring that the plant residues formed after harvesting such as corn, cotton, sunflower, such as corn, cotton and sunflower, by burying stones while processing, by providing the attitude of minerals such as silicon, magnesium, and cobalt, and by shredding plant residues, burying the soil into a depth of 20-30 cm, and by making it transformed into organic fertilizer.

Another advantage obtained by the invention is the ribbon-like processing of the land, that is, to save the workforce, fuel, and time by processing the area we will plant. In addition, the plant we will plant in the field by dividing into two or three, alternately left empty places in the next period offers the possibility of planting. Since the areas that will not be cultivated in the field will be left to rest (fallowing), the yield increase will be achieved in the next year.

The remaining plant residues and stones in the unrelated parts are also playing an important role in irrigation. The remaining residues and stones here prevent drip pipes from flyaway due to the wind, and since it will overshadow, it will keep the land longer.

The system of the present invention allows for applying with any type of tractor, regardless of low or high horsepower with the advantage of weight. Since the desired seed bed will be prepared in a single process in the field, it reduces the necessary workforce, time, and costs.

Equipment such as rotovator, sweep, not running towards the departure direction of the tractor, but work in the opposite direction. The product of the present invention makes strokes and stones, clods and plants to be buried before throwing the roots and stems. Thus, roots and plant residues are more disintegrated, and while the accumulation decreases on the soil surface, the rate of mixing into the soil increases. The stones are buried in the maximum depth where the machine works due to weight. Thus, organic decay is accelerated and soil is made ready for planting more quickly. By means of the present invention, the dependency to the machines used in operations such as the breakdown of after harvesting stalks and branches of crops such as corn and cotton is eliminated.

### BRIEF DESCRIPTION OF THE DRAWINGS

FIG. 1: The general view of the present invention

FIG. 2: The perspective view of the present invention

FIG. 3: Crusher system driving group

FIG. 4: The general perspective view of the present invention

FIG. 5: Crusher system Shaft Group

FIG. 6: The general view of the present invention

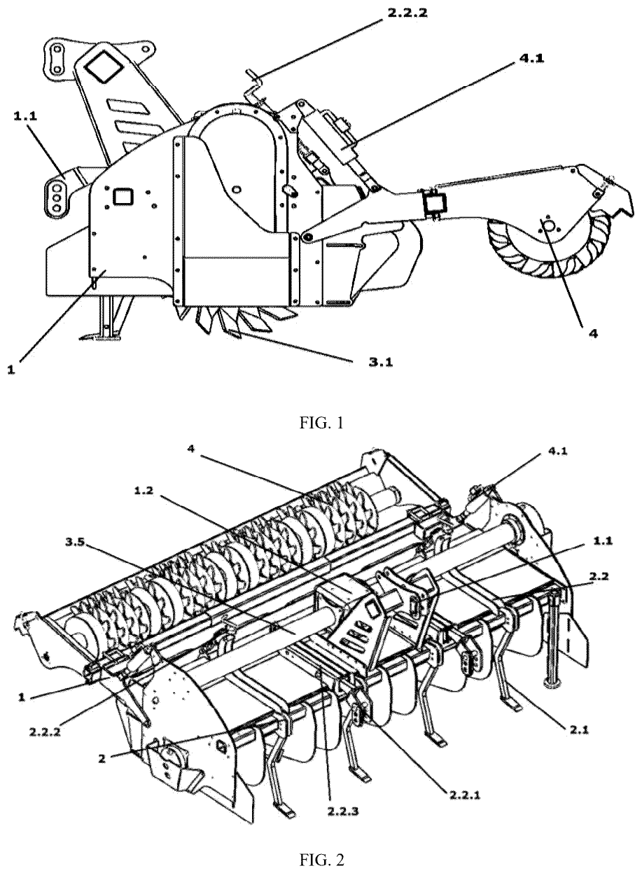

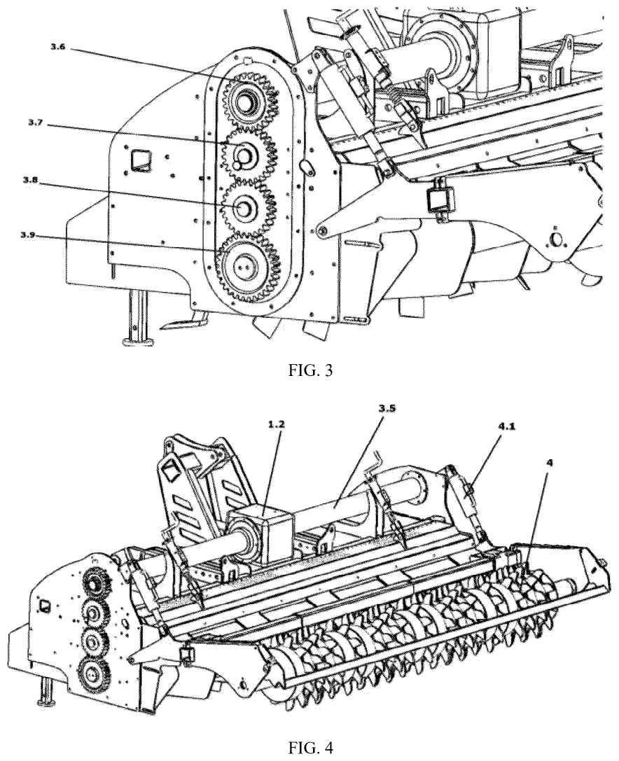

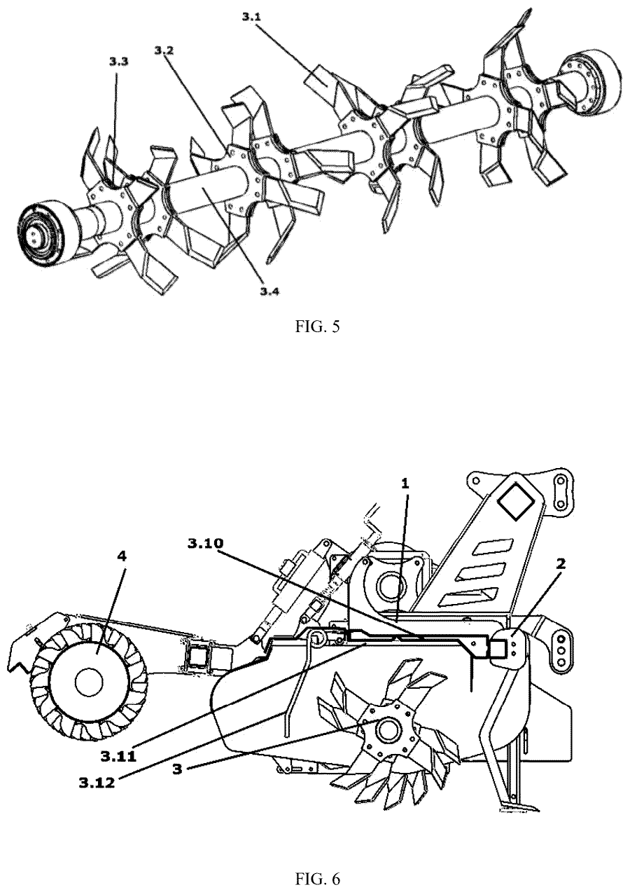

### REFERENCES IN FIGURES

1. Main Chassis
1.1 three-point linkage
1.2 transmission box
2. Blasting System
2.1 blasting blade
2.2 Depth Adjusting Mechanism
2.2.1 Adjusting pin
2.2.2 adjusting arm
2.2.3 jack lever
3. Crushing system
3.1 Crushing blade
3.2 Compressing flange
3.3 Retaining flange
3.4 Rotor shaft
3.5 Gear transfer shaft
3.6 Transmission-driven gear
3.7 Direction gear
3.8 Direction gear II
3.9 Rotor shaft gear
3.10 Roof panel
3.11 Side panel
3.12 Spring curtain
4. Roller System
4.1 Hydraulic lift

### DETAILED DESCRIPTION OF THE EMBODIMENTS

The present invention consists of four main systems. Main chassis (1), Blasting system (2), crushing system (3), and roller system (4).

The main chassis (1) is the body where the entire system is collected and the blasting system (2), the crushing system (3) and the roller system (4) are placed respectively. It has three point linkage system (1.1), which allows for connecting the system to the tractor during transplantation. In addition, it has the transmission box (1.2), which allows the crushing system (3) to receive the power required by the tractor during soil processing.

The blasting blade system (1) is the first part where the soil to be prepared for planting is blasted and first processed. It has a blasting blade (2.1), which allows the opening of an area to be created for the preparation of the soil for planting. The main purpose of the blade system (2) is to perform the first blasting process of the soil and then help to reach the desired depth of stone and plant residues. Therefore, the blade system (2) has a depth adjusting mechanism (2.2) that enables the user to reach the desired depth. The depth adjusting mechanism (2.2) is characterized by having at least two on the main chassis (1), close to the ends of the machine in the longitudinal direction.

Depth adjustment mechanism (2.2) consists of adjusting pin and its counterpart (2.2.1) set, and adjusting arm (2.2.2). By rotating the adjusting arm (2.2.2), the blasting system (2) is lowered to the desired depth. The system, which is lowered to the desired processing depth, is fixed by means of the adjusting pin and its counterpart (2.2.1).

The adjusting arm (2.2) has a splined shaft. By means of the splined shaft, the jack lever (2.2.3) can be moved up or down depending on the direction of rotation of the adjusting arm (2.2). Jack lever (2.2.3) brought to the desired distance by means of the jack lever (2.2.3) can be fixed by engaging the adjusting pin (2.2.1) into the adjusting pin slot.

The crushing system (3) is arranged so that the stones and plants are crushed and buried far below the depth at which the seed will germinate in order to pass the most efficient seeding process in blasted soil. It aims to accelerate its organic decay by burying the plant by shredding it much below the depth (7-8 cm) where the seed will germinate.

On the other hand, it is prevented that the stones affect the germination negatively by burying them much below the depth where the seeding is performed. Before the embedding process, it breaks the stones and clods into pieces in much smaller volumes.

The transmission box (1.2) in the crushing system (3) is used to drive the gear transmission shaft (3.5) that it receives from the tractor PTO shaft.

The gear transmission shaft (3.5) transmits the drive it receives from the transmission box (1.2) to the transmission-driven gear (3.6). The transmission driven gear (3.6) ensures that the objects that the crusher blade (3.1) shreds are buried and that it gains the ability to turn in the opposite direction, and transfers it to the direction gear (3.7) and the direction gear II (3.8).

The direction gear II (3.8) transfers the drive it receives to the rotor shaft gear (3.9). The rotor shaft gear (3.9) enables the rotation of the crushing blades (3.1), drive of which is configured on the rotor shaft (3.4). Direction gear (3.7) and direction gear II (3.8) and crushing blades (3.1) are fixed in the same direction as tractor running direction.

With this direction determination, the crushing blades (3.1) hit the soil, stone, and plant blend they have lifted against the roof panel (3.10), and the first crushing operation is provided. All blended content that has fallen falls back onto the blade. For the second hitting operation, the side plate (3.11) is being hit. Thus, a crushing process is achieved by means of the second hit. The stone, which falls by hitting the side panel is falling to the ground due to the density of the plant content, while the fall is delayed by hitting the spring curtain (3.12) due to the density of the soil. Thus, first, the stone and plant fall to the excavated bottom point, and then the burial of plants and stones is ensured by means of the delayed falling of the soil.

The rotor shaft (3.4) provides the clockwise rotation of the crushing blades (3.1) with the movement it receives from the rotor shaft gear ( ) fixed on the crushing blades (3.1). There are retaining flanges (3.3) fixed by welding on the rotor shaft (3.4). The crushing blade (3.1) is fixed between the retaining flange (3.3) and the compressing flange (3.2) with screws and nuts.

The crushing blade (3.1) cuts through the soil with its rotational speed, crushing the plant and stone elements on the soil it has split in accordance with the direction of rotation, and allows for burying at a depth of 20-30 cm.

The results obtained are not sufficient since the machines such as the rotary machines in the available systems make surface treatment and spread it on the land. Therefore, burying plants contributes to the value of soil by organic decay, and stones and clods are divided into smaller pieces and closed below the sprouting depth in order to prevent their development.

The compressing roller system (4) ensures that the blasted soil has a plain ready for planting after the plants and stones are crushed and buried under the planting level. It has hydraulic lifts (4.1) that enable it to be lifted during transportation after the process and to create the desired load on the soil during tillage.

The whole machine system allows for intermittent processing, such as corn, which is planted in rows. By means of this intermittent sowing process, the area where the tractor is resistant during operation is limited only to the rows where sowing will be made. Thus, the power required by the tractor to pull is reduced, which directly affects the cost.

The blasting system (2), crushing system (3) and roller system (4) are arranged intermittently in accordance with the sowing principle of especially corn etc. products. Thus, only the row parts to be planted are processed and the required energy is saved. With the intermittent processing method, only the area to be planted is processed. The fact that the stones are not buried in untreated areas also brings benefits such as seed shading. The blasting system (2), crushing system (3), and roller system (4) are arranged intermittently in accordance with the sowing principle of especially corn etc. products.

### The Intermittent Configuration

directly reduces the number of blasting blades (2.1). The blasting blade system (2) reduces the energy that the tractor will consume as the strength it will encounter in the pulling process decreases since the tractor operates with the pulling force, the number of blades (2.1) required for processing the required row of ground is reduced. Thus, cost reduction is achieved. At the same time, it is beneficial to minimize the total weight of the machine.

The crushing blade system (3) works with the transmission of the drive it receives from the transmission box (1.2). By arranging the crushing blades (3.1) in pairs, spaced so that they only process the areas to be planted, and as the number of crushing blades (3.1) that the transmission box needs to apply force and turn decreases, the required force decreases. On the other hand, the total weight of the machine is significantly reduced.

The roller system (4) is arranged in a number suitable for the number of rows, following the same alignment in accordance with the blast blade system (2) and the crushing blade system (3), not as a solid roller rotating on a single spindle as it targets rows to be machined. Thus, each roller works independently of the other on its own turn, and the failure of one roller does not affect the other in case of possible malfunctions.

1. An agricultural machine that prepares soil for planting of grains that are sown in rows, such as corn, comprising;
a main chassis having a transmission box that transfers power taken from a tractor to a crushing system, and to a three-point linkage that connects the blasting system, crushing system, and roller system to the tractor during transportation;
a blasting system that has a blasting blade that enables the soil to be prepared for planting to be blasted and raised, adjustment pin and its counter part that allow the blasting blade to reach the desired depth, and at least two depth adjusting mechanisms consisting of a splined shaft, adjusting arm, and a jack lever;
ensuring that stones and plants are crushed and buried below the depth at which the seed will germinate for the most efficient seeding in blasted soil;
crushing blades that hit the stones and herb blend against a roof panel and hit all falling blended content into a side panel for a second hitting process;
a spring curtain that allows the fall of the stones, which hits the side panel, to the soil due to the density of plant content, while delaying the fall due to the density of the soil;
a direction gear II, which transfers drive it receives to a rotor shaft gear, which enables the rotation of the crushing blades configured on the rotor shaft, direction gear, which enables the drive taken from the transmission box to bury the objects broken by the crushing blade and to gain the ability to turn in the opposite direction, and a gear transmission shaft that transfers it to a transmission driven gear, which transfers it to the direction gear II,
a roller system that can be lifted upwards with a hydraulic lift.
